(19) United States
(12) Patent Application Publication
(10) Pub. No.: US 2011/0120267 A1
(43) Pub. Date: May 26, 2011

(54) Iron Precipitation

(76) Inventor: Eric Girvan Roche, New South Wales (AU)

(21) Appl. No.: 12/991,985

(22) PCT Filed: Jun. 25, 2009
(86) PCT No.: PCT/AU2009/000812

§ 371 Date: Dec. 30, 2010

(30) Foreign Application Priority Data
Jun. 25, 2008 (AU) 2008903233

(51) Int. Cl. C22B 23/00; C01G 51/00; C01G 53/00

(52) U.S. Cl. 75/711; 423/139; 423/140

(57) ABSTRACT

A process for the treatment of a solution containing at least ferric ions, and one or more metal values, said process including the step of maintaining a controlled concentration of ferric ions in solution for a sufficient residence time to control iron hydroxide or oxide crystal growth, and precipitating the iron as a relatively crystalline iron hydroxide or oxide while minimising the loss of the ore or more metal values with the iron hydroxide or oxide.

The present invention resides in a process for treating a solution that contains at least ferric ions together with one or more metal values. In the process, the concentration of ferric ions in solution is controlled for a sufficient residence time in a tank or vat to control iron hydroxide or oxide crystal growth. In one form, the crystal growth will be enhanced by the presence of iron hydroxide or oxide seeds leading to precipitating the iron as a relatively crystalline iron hydroxide or oxide that contains less than 0.05% of the metal value. The process is able to be operated at ambient or elevated temperatures. In a preferred form, the iron is precipitated as goethite. The process is particularly applicable to processes for the recovery of nickel and/or cobalt from laterite acid leach processes.

### BACKGROUND OF THE INVENTION

The removal of iron and aluminium is usually required before the recovery of many metal values from solution. In nickel and cobalt recovery processes, iron and aluminium are usually precipitated from an acidic pregnant leach solution (PLS) prior to the recovery of nickel and cobalt.

A common process for iron precipitation is to precipitate goethite, jarosite, hematite or other iron hydroxides or oxides from the PLS. Aluminium may also be precipitated as its oxide or hydroxide. Typical conditions to carry out goethite precipitation would be to adjust the PLS to a pH of about 3 and at 70-90° C. using an alkaline reagent such as a limestone slurry. In a conventional plant with three stirred tanks in series, this works reasonably well, but nickel losses to the solids may be 5%-20% depending upon the nickel tenor in the solution.

Further, the precipitates can be voluminous and cause difficulty with disposal. There can also be considerable energy usage with the need to heat the solution to achieve adequate iron precipitation. It is however, the potential loss of valuable metal that is absorbed on to the iron hydroxide as they are precipitated, or precipitates with the iron, that is an economic disadvantage in current processes.

U.S. Pat. No. 3,954,937 in the name of Fernand Bodson describes a process for the treatment of a material containing zinc and soluble silica. In this process, dilute aqueous solutions of sulfuric acid are progressively added to the zinc containing material over a period of time while carefully maintaining the temperature conditions to between 70° C. to 90° C., which induces lixiviation of the material and simultaneously the re-precipitation of silica in a crystalline form which can readily be separated by filtration. This document shows one example of the formation of a crystalline material to remove silica from the material to enable an improved recovery of the metal value.

It is a desired feature of the present invention to develop a process to reduce the losses of metal values in a metal value recovery process, by improving the crystallinity of iron hydroxide or oxide precipitate.

It is a further feature of the present invention to develop a process that may be operated at ambient temperature while minimising the loss of metal values.

A reference herein to a patent document or other matter which is given as prior art is not to be taken as an admission that that document or matter was known or that the information it contains was part of the common general knowledge as at the priority date of any of the claims.

### SUMMARY OF THE INVENTION

The present invention relates to a process for treating solutions that contain at least ferric ions and one or more metal values in solution, and precipitating the ferric ions as an oxide or hydroxide while minimising the loss of the metal values. This is achieved by controlling the concentration of ferric ions in solution, which enhances formation of iron hydroxides or oxide crystallisation and inhibits nucleation. It further lowers the absorption capacity of the precipitated solids and can reduce the loss of metal values that may precipitate on or within the iron hydroxide or oxide.

Growing crystals is a well known method for excluding impurities from the material being crystallised. This occurs because the thermodynamically preferred outcome is for molecules of the compound being crystallised to insert themselves into the regular lattice pattern of the growing crystal. Impurities usually fit less well in the lattice, therefore represent a slightly less thermodynamically favoured result. This principle is used widely in purification processes such as recrystallisation and zone refining. However, if precipitation is uncontrolled, kinetic factors may cause incorporation of impurities in the precipitate, such as valuable metals like nickel, copper or zinc. This is an especially common occurrence during the precipitation of iron hydroxides and oxides.

Accordingly, the present invention resides in a process for the treatment of a solution containing at least ferric ions and one or more metal values, said process including the step of maintaining a controlled concentration of ferric ions in solution for a sufficient residence time to control iron hydroxide or oxide crystal growth, and precipitating the iron as a relatively crystalline iron hydroxide or oxide, while minimising the loss of one or more of the metal values with the iron hydroxide or oxide.

In one embodiment, the process is applicable to treating the pregnant leach solution (PLS) from a process for the recovery of one or more metal values where the PLS includes at least ferric and aluminium ions together with the metal value or values. The process is particularly applicable to the recovery of nickel and cobalt where the PLS is the result of an acid leach of a nickel laterite ore, but may also be applicable to other metal values such as copper or zinc. For example, the PLS may be the solution recovered from the heap leach, pressure leach, atmospheric pressure leach or combination thereof of a nickel laterite or sulfide ore, matte or concentrate, but may also be applicable to the bioleach of a copper or zinc containing ore, or an acid leach of any metal value.

Preferably, the solution is treated in a series of tanks such that the concentration of ferric ions in solution is controlled to be in a concentration of from 0.1 to 10 g/L in a first set of tanks. The term “tank or “tanks” used herein has been used to include any form of suitable receptacle(s) for treating solutions in such processes and includes vats and vessels.

Preferably the process is one wherein the solution is treated in a series of tanks; the process including the steps of:
a) continuously feeding a pregnant leach solution from a process for the recovery of one or more metal values to a first set of one or more tanks, the pregnant leach solution containing at least one metal value and from 1 to 120 g/L ferric ions in solution;
b) controlling the pH of the solution to be in the range of from 1.8 to 5;
c) maintaining the ferric ion concentration of the solution in the first sets of tank or tanks to be in the range of from 0.1 to 10 g/L for a residence time of from 1 to 20 hours to favour crystal growth;
d) maintaining a concentration of iron hydroxide or oxide particles equivalent to between 1 and 10 times the amount of iron precipitated from the pregnant leach solution; and
e) precipitating the iron as an iron hydroxide or oxide from the solution in a relatively crystalline form while minimising the loss of one or more metal values with the iron hydroxide or oxide.

Preferably, the residence time in the first set of tank or tanks is for a period of between 2 to 10 hours.

It has been found, that by improving the crystallinity of the precipitated iron hydroxide or oxide that the crystal growth is enhanced and nucleation is inhibited. There is therefore an improved tendency for the iron to precipitate on the surface of the iron hydroxide or oxide particles, rather than to nucleate and form more smaller particles. By this means, the iron is able to precipitate without the tendency of the metal value, for example nickel, to be absorbed with/in the precipitated iron hydroxide or oxide.

For example, the applicants have found that less than 5% of the metal value, contained in the PLS is co-precipitated or lost from the recovery process. By comparison, as much as 20% of the metal value may be precipitated by poorly controlled precipitation of ferric ions, particularly when performed at ambient temperature. The applicants have found that an iron precipitate can be produced containing less than 0.05 wt %, and at times less than 0.01 wt % of the metal value, resulting in considerably less metal value lost from the recovery process.

The first set of tanks preferably are arranged in a parallel or series arrangement whereby the PLS resides in the first tank for a sufficient period of time to maintain a ferric ion concentration preferably in the range of from 0.1 to 10 g/L. The first set of tanks may include at least two tanks, preferably three or more, arranged in a series or parallel arrangement. The PLS is fed into the first set of tanks where the pH of the solution is maintained at a level of from about 1.8 to 5 in order to precipitate the iron as an iron hydroxide or oxide. The PLS preferably contains from about 1 to 120 g/L ferric ions in solution, but more preferably would include from 10 to 50 g/L ferric ions. The first set of tanks may be arranged such that there is sufficient residence time so as to reduce the ferric ion concentration to about 0.1 to 10 g/L, preferably about 1 g/L, following the precipitation of iron as a hydroxide or oxide.

The applicants have found if the pH is controlled in a series or parallel tank arrangement as described above, say at a pH level within the range of from 1.8 to 2.4, that the precipitate will include only very low levels of nickel within the iron oxide or hydroxide complex. This arrangement is particularly applicable to processing the PLS from an atmospheric agitation leach, or a pressure leach where the temperature of the PLS is elevated to a temperature of say 80° C. to 90° C.

The applicants have also found that where the PLS is at ambient temperature, for example from a heap leach process, the iron precipitate will be inhibited until a pH of at least 3.0 is achieved. At a pH of at least 3.0, it is likely that there will be greater losses of nickel, which would be avoided at lower pHs.

Accordingly, in another embodiment of the invention, which is particularly applicable when the PLS is at ambient temperatures, the tanks may be arranged in a series arrangement wherein the pH of the solution is lowered between confluent tanks as the solution passes from one tank to the next. The pH is preferably controlled initially to be in the range of greater than 3.0 to initiate precipitation of iron as an hydroxide or oxide, and is progressively lowered by about 0.5 to 1.0 between confluent tanks to minimise nickel losses.

With this pH control, and a suitable residence time within each tank, the iron hydroxide or oxide is able to crystallise and precipitate without significant nickel losses while maintaining the PLS at ambient temperatures. A preferred arrangement has been found to have a pH of about 3.5 in the first tank, and lower pH in confluent tanks, for example to 3.0 and then 2.5, to minimise nickel losses.

As the pH is lowered from tank to tank, the increased amount of seed particles offsets the lower pH and keeps the precipitate crystalline, and overcomes the reduction in precipitation kinetics. At the same time, the lower pH redissolves precipitated metal value and inhibits further co-precipitation. Once precipitated, the crystalline iron hydroxide or oxide is kinetically stable enough that the lower pH in the end tanks does not significantly redissolve the iron. The pH may be selected from the range 5.5 to 0.5, but at ambient temperatures, is preferably initiated at a pH of about 3.5, and the lowering of the pH from tank to adjacent tank may be any step but is preferably either 0.5 to 1.0 between adjacent tanks.

In one embodiment, the tanks may be arranged in series such that the first tank is larger than subsequent tanks to allow for greater residence time in the first tank, therefore establishing a ferric ion concentration in the range of from 0.1 to 10 g/L in a shorter period of time.

The solution entering the tanks may be at ambient temperature, preferably as a result of a leach process conducted at ambient temperature. When the solution is at ambient temperature, it has been found that it is preferred to initiate precipitation of the iron at a pH of greater than 3 and to steadily reduce the pH in subsequent tanks in order to minimise nickel and cobalt losses. The process may be maintained at the ambient temperature through the iron precipitation stage.

In some circumstances, the PLS may be at elevated temperatures of up to 100° C. and in such circumstances, iron may be precipitated as oxide or hydroxide at lower pHs, for example from about 1.8 to 2.4.

Most preferably, the iron is precipitated as goethite at ambient temperature by controlling the pH in the first tank to be in the range of from 3.0 to 5.0 and subsequently lowering the pH in each confluent tank by approximately 0.5 to 1.0, such that the resulting precipitated iron hydroxide or oxide contains less than 0.05% by weight of the metal value, preferably less than 0.01%, and overall, there are losses of metal values below 5% by weight.

The iron hydroxide or oxide particles that are maintained in the solution may act as seeds for crystal formation. Crystal growth is enhanced with the addition of an iron hydroxide or oxide seed and nucleation is inhibited. By operating the tanks at a low ferric ion content, for example 1 g/L at ambient temperature, favours crystal growth over nucleation and the ferric ion will precipitate as a relatively crystalline iron hydroxide or oxide. Preferably, a concentration of iron hydroxide or oxide particles equivalent to between 1 and 10 times the amount of iron precipitated from the PLS is maintained in the solution, which can act as a seed for iron formation.

In another embodiment, an iron hydroxide or oxide seed may be added to the solution to assist in initiating crystal formation. In this embodiment the iron containing seed may be added from an external source, or internally recycled from within the process. A preferred embodiment is to recycle a thickener underflow of the iron hydroxide or oxide, returning this slurry to the precipitation vessels as a source of seed particles.

A non-calcium alkali is preferably added to the first tank or tanks to control the pH. This has the advantage in that it will produce a relatively pure goethite precipitation. For example, the non-calcium alkali may be selected from magnesium oxide, magnesium hydroxide, magnesium carbonate or may even be the saprolite ore from post mining separation of a laterite ore. Preferably, the magnesium oxide or hydroxide may be recycled for use in the process in the manner described in International applications PCT/AU2006/000094, PCT/AU02005/001497, PCT/AU2006/001983 and PCT/AU2006/001984, each in the name of BHP Billiton. The non-calcium alkali is able to control the pH to produce a relatively pure goethite precipitate.

Preferably, aluminium is also co-precipitated together with the iron hydroxide or oxide. The aluminium would generally precipitate as an aluminium hydroxide and will precipitate under the pH conditions together with the iron hydroxide or oxide. Precipitation of the aluminium oxide or hydroxide may usefully be controlled in the same manner to produce a relatively crystalline aluminium oxide or hydroxide, without loss of the metal value.

An oxidant may be added to the solution to oxidise any ferrous iron to ferric iron. This could be done as an independent step, or may be added to the solution in the first or subsequent set of tanks. Preferably the oxidant is air sparged into the solution, for example in the first or subsequent tanks, or prior to feeding the solution to the first tank.

A calcium containing alkali such as limestone, lime, dolime or dolomite may also be added to the first and subsequent tanks, in which case the goethite precipitate will contain gypsum.

The metal value or values is/are recovered from the solution leaving the first set of tanks, which solution is substantially free of iron and aluminium impurities. For example, in a process for the recovery of nickel and cobalt, the nickel and cobalt may be recovered from the solution by either mixed hydroxide precipitation, sulfide precipitation, ion exchange or solvent extraction, or other recognised means for the recovery of such metal values.

### BRIEF DESCRIPTION OF THE DRAWINGS

FIG. 1 shows a parallel-series tank arrangement whereby a product leach solution is fed into a parallel arrangement of tanks, which discharge into a series arrangement of tanks.

FIG. 2 shows a series-series tank arrangement whereby a product leach solution is fed into tanks in a series arrangement.

### DETAILED DESCRIPTION OF THE INVENTION

The invention will be described with reference to the accompanying Drawings. It should be kept in mind that these Drawings are illustrative of preferred embodiments of the invention, and the invention should not be considered to be limited thereto.

The feed PLS may be a leach solution from any leach process. For example, in a preferred embodiment, it is the PLS from an acid heap leach of a nickel laterite ore, but may also be the process of one, or a combination of an atmospheric, pressure or bioleach process of other ores containing metal values. The PLS will generally contain anywhere from 1 to 120 g/L ferric ions in solution, but in a typical embodiment where the PLS is sourced from a heap leach of a nickel laterite ore, the ferric ion content will be in the order of about 30 g/L, together with other impurities such as aluminium, chromium, manganese, and magnesium, and the metal values nickel and cobalt.

The feed PLS may be oxidised, for example by sparging air into the tanks or prior to feeding into the first set of tanks, in order to oxidise any ferrous iron present to ferric. Preferably, the air is sparged into the latter tanks in the series, as this avoids foam problems and because the iron concentration is already low, the ferric iron formed by oxidation naturally precipitates in crystalline form.

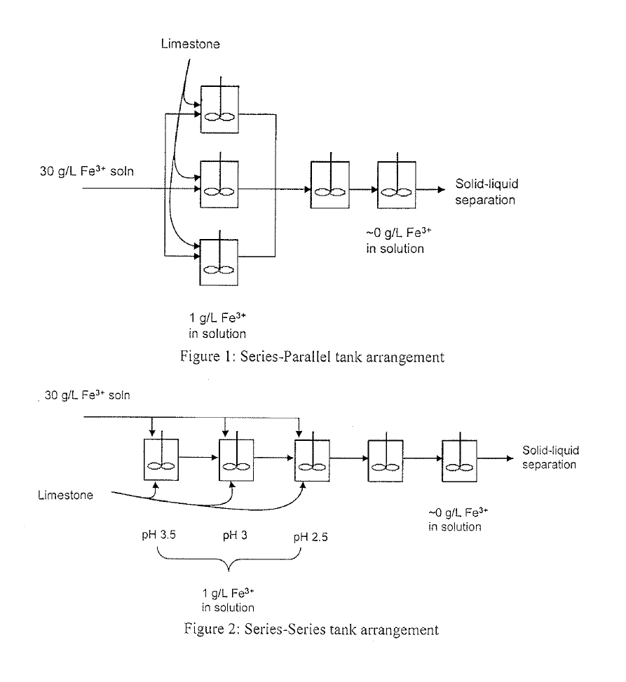

In the embodiment illustrated in FIG. 1, the feed PLS is divided into three tanks of equal size. This gives a threefold increased residence time of the PLS within the first set of tanks. A calcium containing alkali, such as a limestone slurry is added to the tanks so as to maintain the pH at the desired level to precipitate the iron as an iron hydroxide or oxide product. Acid, or an additional amount of PLS, may also be added if necessary to control the pH to the desired level. The iron hydroxide or oxide product will also contain gypsum. Alternatively a non-calcium containing alkali such as magnesium hydroxide, oxide or carbonate or even saprolite from a laterite processing operation may be added to produce relatively pure goethite product.

The PLS is continuously fed into the tanks and the residence time is such that upon precipitation of the ferric hydroxide or oxide, the operating conditions in the first tank is such that it will maintain a ferric ion content of about 0.1 to 10 g/L ferric ion solution, but preferably around 1 g/L. The residence time in the three tanks will generally be anywhere from 1 to 20 hours, preferably from 2 to 10 hours, or until a steady state of ferric ion concentration of from about 0.1 to 10 g/L is achieved.

FIG. 2 illustrates an alternative embodiment where the tanks are arranged in a series. The pH of the solution is steadily lowered between the confluent tanks, and as illustrated in FIG. 2, the first tank has an initial pH of 3.5, and the pH is progressively lowered to a pH of 3 and a pH of 2.5 in the subsequent tanks. If desired the pH may be raised in the final tank or tanks to aid the precipitation of aluminium and other impurities such as chromium. This arrangement is particularly applicable to when the PLS is at ambient temperatures.

In an alternative arrangement to the tanks illustrated, the first tank may be a large tank, followed by smaller tanks which would give a relatively greater residence time within the first tank.

Subsequent to exiting the first set of tanks, the solution is substantially free of iron and the precipitated iron hydroxide or oxide contains less that 0.05% by weight of metal value, preferably less than 0.01% resulting in less than 5% by weight loss of metal value. Aluminium would also have co-precipitated with the ferric oxide or hydroxide. The solution then undergoes a solid/liquid separation step wherein the precipitated iron and aluminium oxides and hydroxides are removed.

If desired, a part of the separated precipitate may be recycled to the first tank or subsequent tanks to act as a seed for crystal growth.

The solution, substantially free of iron and aluminium impurities, is then processed for recovery of the metal value or values. In the case of recovering nickel and cobalt, the nickel and cobalt may be recovered by either mixed hydroxide precipitation, sulfide precipitation, ion exchange or solvent extraction, or a combination thereof.

A particular advantage of the process of the present invention is that there is substantial reduction of lost metal value, as it would not be lost with the iron precipitation, to any significant extent, as may happen with current processes. A potential application of the process is to process the PLS from an acidic heap leach process of nickel laterite ore, although it has broader applications to other processes, such as bioleach, atmospheric or pressure leach process, or other metal values. As the process is able to operate effectively at ambient temperatures, the PLS from a heap leach process is able to be fed directly for treatment in the process of the present invention.

A further benefit of increasing the crystallinity of the precipitated iron hydroxide or oxide product, is that the solid/liquid separation characteristics of the precipitate are improved, leading to better thickening and filtration characteristics, and also a more compact material for disposal.

### EXAMPLES

### Example 1

### Comparative Example

A solution (2.5 L) containing nickel and iron sulfates was placed in a baffled reaction vessel equipped with a mechanical stirrer. The vessel was heated with stirring to raise the solution temperature to 85° C., which was the control temperature throughout the experiment. A slurry of limestone in water (25% w/w) was pumped into the reactor to reach and maintain a pH of 3.0. A small amount of concentrated H₂SO₄ was added to correct the pH to this level where necessary. After stirring for 25 minutes the contents of the vessel were decanted and a settling test and a vacuum filtration test were carried out on two 1 L samples of the slurry. On completion of these tests the combined slurry was filtered and the filter cake washed well with water. A sample of the solids was dried and subjected to assay by XRF.

### Example 2

### Controlled Goethite Precipitation at Constant pH

Water (500 mL) was placed into the same baffled reaction vessel as described in Example 1. The vessel was heated with stirring to raise and maintain the vessel contents at 85° C. throughout the experiment. A sample of solution (2.5 L) as used in Example 1 was pumped into the reactor over a period of 2.5 hours, at a rate controlled to maintain a ferric ion concentration between 1.1 and 2.5 g/L. The rate of solution pumping was increased from 9 mL/min at the start of the experiment to 46 mL/min at the end of the experiment in order to maintain the ferric ion concentration in this range. A slurry of limestone in water (25% w/w) was simultaneously pumped into the reactor to reach and maintain the pH at 2.0. On completion of the 2.5 hours the reaction vessel contents were decanted and treated as in Example 1.

### Example 3

### Controlled Goethite Precipitation at Constant pH and Ambient Temperature

Water (500 mL) was placed into the same baffled reaction vessel as described in Example 1. A sample of solution (2.5 L) as used in Example 1 was pumped into the reactor over a period of 2.5 hours, at a rate controlled to maintain a ferric ion concentration between 0.22 and 0.31 g/L. The rate of solution pumping was increased from 9 mL/min at the start of the experiment to 46 mL/min at the end of the experiment in order to maintain the ferric ion concentration in this range. A slurry of limestone in water (25% w/w) was simultaneously pumped into the reactor to reach and maintain the pH at 3.0. The temperature was allowed to remain at the ambient temperature of 21° C. throughout the experiment. On completion of the 2.5 hours the reaction vessel contents were decanted and treated as in Example 1.

### Example 4

### Controlled Goethite Precipitation at Stepwise pH at Ambient Temperature

Water (500 mL) was placed into the same baffled reaction vessel as described in Example 1. A sample of solution (2.5 L) as used in Example 1 was pumped into the reactor over a period of 2.5 hours, at an increasing rate from 7 mL/min at the start of the experiment to 30 mL/min at the end of the experiment. The temperature was allowed to remain at the ambient temperature of 21° C. during the experiment. The limestone slurry in this case was again simultaneously pumped into the reactor, but for the initial 50 minute period the pH was controlled at 3.5, then 3.0 for 50 minutes, then pH 2.5 for the final 50 minute period. During the initial 50 minutes the ferric concentration was 0.1-0.2 g/L, the next 50 minutes 0.6-0.8 g/L and the final 50 minutes 4.8-5.8 g/L. On completion of the 2.5 hours the reaction vessel contents were decanted and treated as in Example 1.

The results of each experiment are shown in Tables 1-3.

TABLE 1
Solution Compositions

| | | Al | Ca | Co | Fe | Mn | Ni |
|---|---|---|---|---|---|---|---|
| Example | Time | (g/L) | (g/L) | (g/L) | (g/L) | (g/L) | (g/L) |
| 1 | Start | 4.02 | ND | 0.19 | 26.7 | 2.12 | 3.96 |
| | End | 0.02 | 0.48 | 0.11 | 0.01 | 1.40 | 2.14 |
| 2 | Start | 4.18 | 0.02 | 0.20 | 27.8 | 2.14 | 4.36 |
| | End | 2.13 | 0.64 | 0.15 | 1.53 | 1.61 | 3.12 |
| 3 | Start | 4.15 | ND | 0.20 | 28.7 | 2.09 | 4.43 |
| | End | 2.37 | 1.06 | 0.14 | 0.69 | 1.52 | 2.97 |
| 4 | Start | 3.88 | 0.02 | 0.20 | 28.4 | 2.13 | 4.12 |
| | End | 2.67 | 0.63 | 0.14 | 5.56 | 1.45 | 2.82 |

ND = Not Detectable

TABLE 2
Solid Compositions

| | | Al | Ca | Co | Fe | Mn | Ni |
|---|---|---|---|---|---|---|---|
| Example | Time | % | % | % | % | % | % |
| 1 | End | 2.0 | 20.5 | 0.03 | 12.7 | 0.04 | 0.28 |
| 2 | End | 0.65 | 20.9 | ND | 13.7 | ND | 0.0015^{‡} |
| 3 | End | 1.9 | 16.5 | 0.03 | 15.5 | ND | 0.08 |
| 4 | End | 0.2 | 14.7 | ND | 19.2 | ND | 0.007 |

ND = Not Detectable
^{‡} = By digestion and ICP: below XRF detection limit

TABLE 3
Experimental Results

| | | Lime- | Settled | | | |
|---|---|---|---|---|---|---|
| | | stone | slurry | Filtration | Cake | Ni lost to |
| | Experiment | used | volume | Form Time | Moisture | solids |
| Example | temperature | (g) | (mL)^{§} | (s) | (% w/w) | (%)^{‡} |
| 1 | 85° C. | 359 | 630 | 53 | 58 | 17.5 |
| 2 | 85° C. | 226 | ND | ND | 26 | 0.2 |
| 3 | 21° C. | 252 | 390 | 13 | 46 | 3.6 |
| 4 | 21° C. | 235 | 580 | 52 | 49 | 0.1 |

^{§} = For a 1 L sample of slurry after 1 hour, flocculated with 30 ppm non-ionic flocculant
^{‡} = Relative to weight of nickel in the initial 2.5 L solution sample
ND = Not Determined

The results in Tables 2 and 3 for Example 2 demonstrate very low co-precipitation of nickel with the goethite precipitate by controlled crystallisation at 85° C. at pH 2.

Example 3 in the same tables demonstrates that low coprecipitation of nickel with iron can be obtained by controlled crystallisation at ambient temperature at pH 3.

Example 4 in these tables furthermore demonstrates that very low coprecipitation of nickel can be obtained at ambient temperature by controlled crystallisation with a stepwise reduction of the pH from 3.5 to 3.0 and thence to 2.5.

The invention described herein is acceptable to variations, modifications and/or additions other than those specifically described and it is to be understood that the invention includes such variations, modifications and/or additions which fall within the spirit and scope of the above Description.

1. A process for the treatment of a solution containing at least ferric ions, and one or more metal values, said process including the step of maintaining a controlled concentration of ferric ions in solution for a sufficient residence time to control iron hydroxide or oxide crystal growth, and precipitating the iron as a relatively crystalline iron hydroxide or oxide while minimising the loss of the one or more metal values with the iron hydroxide or oxide.

2. A process according to claim 1 wherein the iron is precipitated as goethite.

3. A process according to claim 1 wherein the solution is maintained at a ferric ion concentration of from 0.1 to 10 g/L for a residence time of from 1 to 20 hours.

4. A process according to claim 1 wherein the solution is a pregnant leach solution from a process for the recovery of one or more metal values, wherein the pregnant leach solution includes at least ferric and aluminium ions together with one or more of the metal values in solution.

5. A process according to claim 1 wherein the solution is treated in a series of tanks; the process including the steps of:
a) continuously feeding a pregnant leach solution from a process for the recovery of one or metal values to a first set of one or more tanks, the pregnant leach solution containing at least one metal value and from 1 to 120 g/L ferric ions in solution;
b) controlling the pH of the solution to be in the range of from 1.8 to 5;
c) maintaining the ferric ion concentration of the solution in the first tank or tanks to be in the range of from 0.1 to 10 g/l for a residence time of from 1 to 20 hours to favour crystal growth;
d) maintaining a concentration of iron hydroxide or oxide particles equivalent to between 1 and 10 times the amount of iron precipitated from the pregnant leach solution; and
e) precipitating the iron as an iron hydroxide or oxide from the solution in a relatively crystalline form.

6. A process according to claim 5 wherein the process is conducted in the first set of tanks at a temperature from ambient to 100° C.

7. A process according to claim 5 wherein less than 5% by weight of metal values is precipitated with the iron oxide or hydroxide.

8. A process according to claim 5 wherein the resulting precipitated iron hydroxide or oxide contains less than 0.05% by weight of the metal value.

9. A process according to claim 5 wherein the metal value is one or more of nickel, cobalt, copper or zinc.

10. A process according to claim 5 wherein the pregnant leach solution is the result of an acid leach of a nickel laterite ore.

11. A process according to claim 8 wherein the leach is a heap leach, bioleach, pressure leach, atmospheric pressure leach or a combination thereof.

12. A process according to claim 5 wherein the first set of tanks are arranged in a parallel or series arrangement wherein the process is conducted at a temperature between 80° C. and 90° C., and the pregnant leach solution resides in the first tank for a sufficient period of time to maintain a ferric ion concentration of 0.1 to 10 g/L.

13. A process according to claim 12 where the pH of the solution in the first tank is controlled to be between 1.8 and 2.4.

14. A process according to claim 5 wherein the process is conducted at ambient temperature and the first set of tanks includes at least two tanks arranged in a series or parallel arrangement, where the pH of the solution is lowered between confluent tanks.

15. A process according to claim 14 wherein the pH of the first tank is controlled to be in the range of from 3.0 to 5.0 to initiate precipitation of iron as an oxide or hydroxide.

16. A process according to claim 14 wherein the pH of the solution is lowered by approximately 0.5 to 1.0 between confluent tanks.

17. A process according to claim 5 wherein the tanks are arranged such that the first tank is larger than the subsequent tanks to allow for greater residence time in the first tank, and the pregnant leach solution resides in the first tank for a sufficient period of time to maintain a ferric ion concentration of 0.1 to 10 g/l.

18. A process according to claim 14 wherein the iron is precipitated as goethite at ambient temperature by controlling the pH in the first tank to be in the range of from 3.0 to 5.0 and subsequently lowering the pH in each confluent tank by approximately 0.5 to 1.0, such that the resulting precipitated iron hydroxide or oxide contains less than 0.05% by weight of the metal value.

19. A process according to claim 5 wherein iron hydroxide or oxide particles that are maintained in the solution act as seeds for crystal formation.

20. A process according to claim 5 wherein an iron hydroxide or oxide seed is added to the solution to assist in crystal formation.

21. A process according to claim 5 wherein aluminium is co-precipitated together with the iron hydroxide or oxide.

22. A process according to claim 1 wherein an oxidant is added to the solution to oxidise ferrous iron to ferric iron.

23. A process according to claim 22 wherein the oxidant is sparged air.

24. A process according to claim 5 wherein a non-calcium alkali is added to the first and subsequent tank or tanks to control the pH to produce a relatively pure goethite precipitate.

25. A process according to claim 24 wherein the non-calcium alkali is magnesium oxide, magnesium hydroxide, magnesium carbonate or saprolite ore.

26. A process according to claim 5 wherein a calcium containing alkali such as limestone, lime, dolime or dolomite is added to the first and subsequent tank or tanks and the goethite precipitate contains gypsum.

27. A process according to claim 5 wherein metal value or values is/are recovered from the solution leaving the first set of tanks.

28. A process according to claim 27 wherein nickel and cobalt are recovered from the solution by either mixed hydroxide precipitation, sulfide precipitation, ion exchange or solvent extraction.
